(19) United States
(12) Patent Application Publication
(10) Pub. No.: US 2010/0309574 A1
(43) Pub. Date: Dec. 9, 2010

(54) DETECTING RAMP LOAD/UNLOAD OPERATIONS

(75) Inventors: Shirish Dnyaneshwar Bahirat, Longmont, CO (US); Robert Allen Alt, Longmont, CO (US); Jerome Thomas Coffey, Longmont, CO (US); Michael Joseph Spahn, Longmont, CO (US)

Correspondence Address: Seagate Technology LLC, 1280 Disc Drive, Shakopee, MN, 55379, US

(73) Assignee: Seagate Technology LLC, Scotts Valley, CA (US)

(21) Appl. No.: 12/477,496

(22) Filed: Jun. 3, 2009

(51) Int. Cl. G11B 15/18

(52) U.S. Cl. 360/71; G9B/15.021

(57) ABSTRACT

A method for detecting ramp load/unload operations is disclosed. The method includes measuring a signal value generated by a transducer element during either a ramp unload operation or a ramp load operation in a data storage device. The method further includes analyzing the signal value to determine whether the ramp load operation or the ramp unload operation in the data storage device has occurred.

### BACKGROUND

Data storage devices utilize ramp load/unload technology in order to prevent damage to the data storage medium. In a data storage device, read/write operations are performed by read/write heads, which are carried by one or more sliders. Each slider is engaged to an actuator arm.

During a ramp load operation, each actuator arm is moved such that it is supported by a surface of a support structure. In this manner, the sliders, and hence the read/write heads, are moved off of the data storage medium prior to power-down, for example, and safely positioned on the support structure. In some instances, an actuator arm may include a lift tab that rests directly on the support structure to hold the slider off the data storage medium. Generally, the support structure includes a shallow ramp on the side closest to the data storage medium. During a ramp unload operation, such as during a power-on sequence, the slider is unloaded by moving the slider off the ramp and over the surface of the data storage medium when the medium has reached the appropriate rotational speed.

### SUMMARY

In one example, the disclosure is directed to a method for detecting a ramp load/unload operation. The method comprises measuring a signal value generated by a transducer element during either a ramp unload operation or a ramp load operation in a data storage device, and analyzing the signal value to determine whether the ramp load operation or the ramp unload operation in the data storage device has occurred.

In another example, the disclosure is directed to a data storage device comprising a data storage medium, an actuator arm comprising a suspension, and a ramp component forming a surface. The data storage device further comprises a transducer element in mechanical communication with the suspension, and a processor in electrical communication with the transducer element. When the slider is unloaded and when the slider is loaded, the transducer element generates a signal. The processor analyzes the signal to determine whether the ramp load operation or the ramp unload operation in the data storage device has occurred.

In another example, the disclosure is directed to a computer-readable medium comprising instructions that cause a processor in electrical communication with a data storage device to measure a signal value generated by a transducer element during either a ramp unload operation or a ramp load operation in a data storage device, and analyze signal value to determine whether the ramp load operation or the ramp unload operation in the data storage device has occurred.

These and various other features and advantages will be apparent from a reading of the following detailed description.

### BRIEF DESCRIPTION OF THE DRAWINGS

FIG. 1 is an illustration of one example of a data storage device including a load/unload ramp.

FIG. 2A is a top view of one example of a suspension engaged to two transducer elements.

FIG. 2B is a bottom view of the example suspension depicted in FIG. 2A.

FIG. 3 is an illustration of one example of a data storage device including electrical connection paths.

FIG. 4 is a conceptual block diagram illustrating one example of a signal path for a ramp load/unload detection circuit.

FIG. 5 depicts a graph illustrating one example of a signal generated by a transducer element during a sequence in which power to the data storage device has been turned off and a load operation has begun.

FIG. 6 depicts a graph illustrating one example of a signal generated by a transducer element during a commanded load operation.

FIG. 7 depicts a graph illustrating one example of a signal generated by a transducer element during a commanded unload operation.

FIG. 8 is a flowchart illustrating an example method for detecting a ramp load/unload operation.

### DETAILED DESCRIPTION

In general, the disclosure describes techniques for detecting ramp contact during ramp load/unload operations of a data storage medium. A transducer signal generated during movement of a suspension may be measured and analyzed in order to determine whether a ramp load operation or a ramp unload operation has occurred. As an example, measurement circuitry may first measure the value of the electrical signal generated by a transducer element engaged to a suspension. Then, a processor may analyze the signal value to determine whether a ramp load/unload operation has occurred.

By using an electrical signal generated by a transducer engaged to the suspension of an actuator arm, the accuracy of ramp load/unload detection may be improved. In addition, detection of a ramp load/unload operation may be simplified by reducing the complexity in detection algorithms. Further, using an electrical signal generated by a transducer engaged to the suspension of an actuator arm to detect ramp load/unload operations may reduce dwell track locations because the ramp load/unload times are accurately known. The electrical signal generated by a transducer engaged to the suspension of an actuator arm during ramp load/unload operations may also be used to perform axial run-out checks. Further still, the electrical signal generated by a transducer engaged to the suspension of an actuator arm during ramp load/unload operations may be used to detect a ramp contact radius and thus mitigate potential head/media contact, media damage, and particle generation. Further still, the electrical signal generated by a transducer engaged to the suspension of an actuator arm during ramp load/unload operations may also be used to detect individual heads or head gimbal assembly contact.

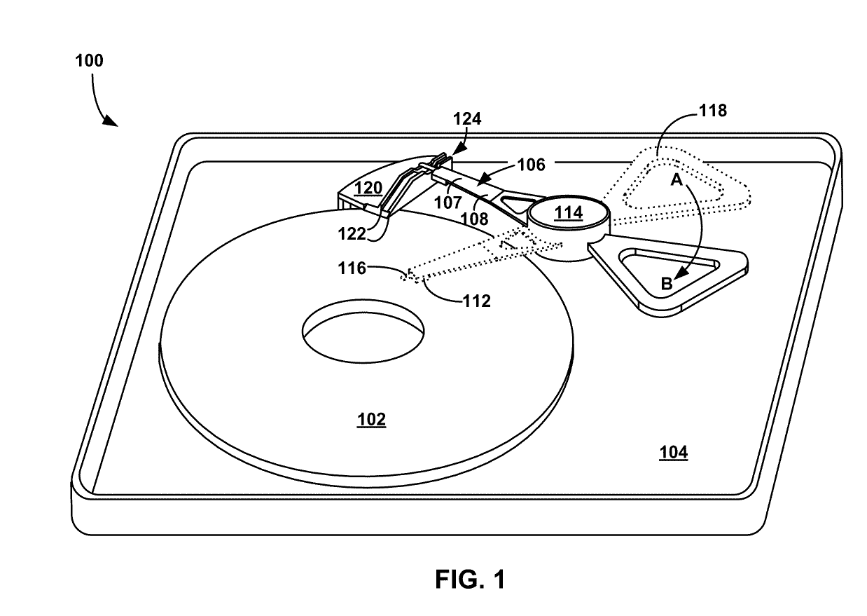

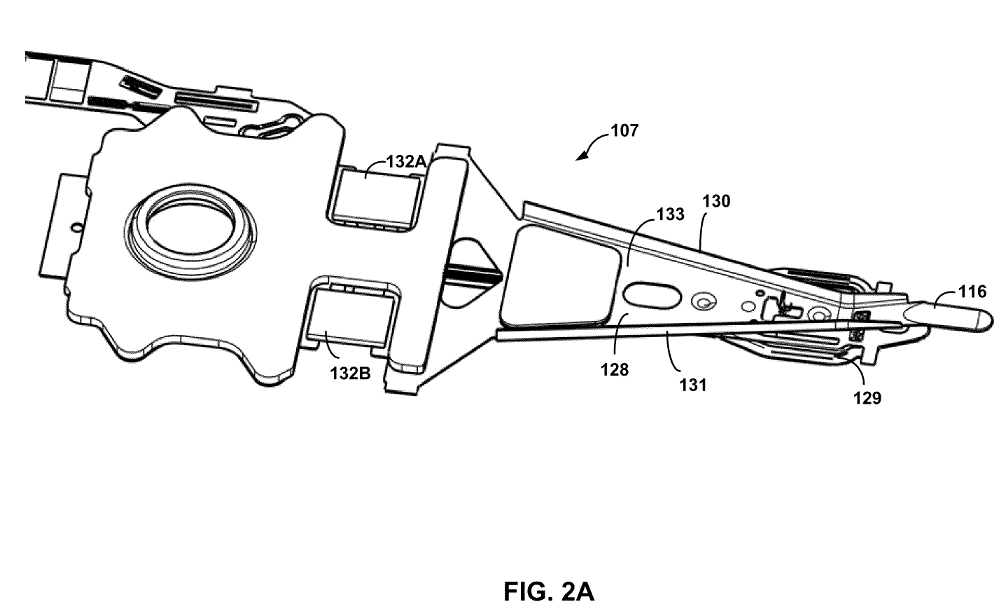

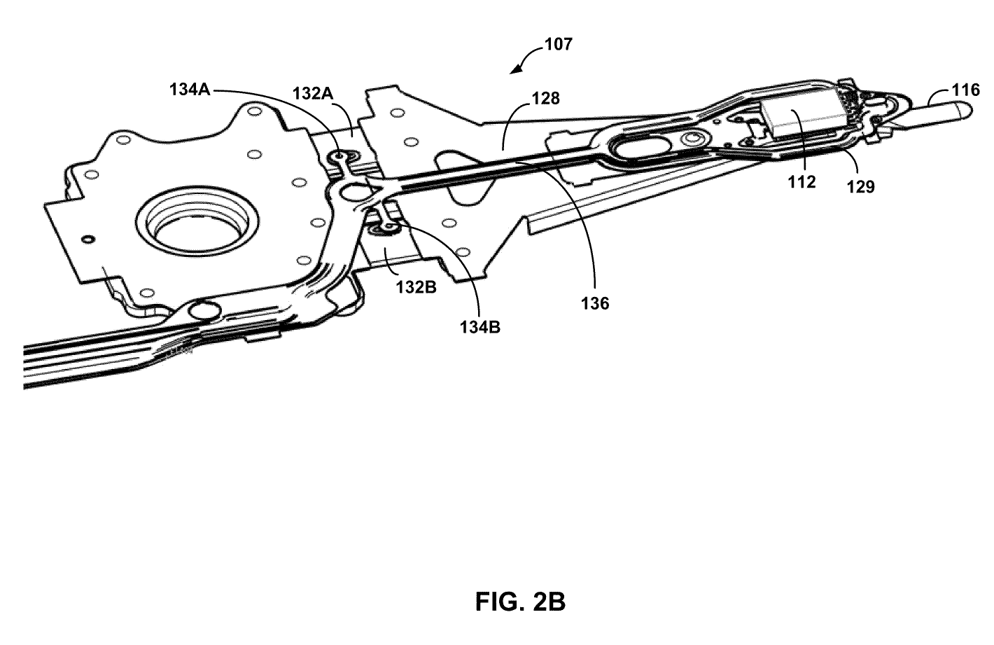

FIG. 1 is an illustration of one example of data storage device 100 including load/unload ramp component 120. Data storage device 100 includes a recordable data storage medium 102 mounted to base 104. For example, data storage medium 102 may be a magnetic disc, optical disc, magneto-optic disc, or other data storage medium. Data storage device 100 also includes an actuator assembly 106, which pivots about bearing shaft assembly 114. Actuator assembly 106 includes actuator arm 108 having suspension 107 and voice coil 118, which interacts with a permanent magnet (not shown) to rotate actuator assembly 106 about bearing shaft assembly 114. Rotating actuator assembly 106 about bearing shaft assembly 114 moves slider 112 across media tracks of data storage medium 102. Slider 112 carries one or more read/write heads, which can record and retrieve data from the recordable surface of data storage medium 102. As will be described in detail below in conjunction with FIG. 2, engaged to suspension 107 are transducer elements used as microactuators that operate to flex a load beam in order to move read/write elements of slider 112 during read and write operations.

Actuator assembly 106 is shown in two positions: A and B. As shown with position A, slider 112 is in an unloaded position, in which data storage device 100 may be performing a read or write operation. In contrast, position B shows slider 112 in a loaded position. For example, actuator assembly 106 may rotate slider 112 into a loaded position prior to a power-down of data storage device 100 or in response to a load command.

To reach a loaded position, voice coil 118 interacts with a permanent magnet (not shown) to rotate actuator assembly 106 off data storage medium 102. As actuator assembly 106 reaches the outer diameter of data storage medium 102, lift tab 116 interacts with ramp component 120. Specifically, after lift tab 116 contacts surface 122 of ramp component 120, further rotation of actuator assembly 106 causes lift tab to slide up surface 122 of ramp component 120. Actuator arm 108 flexes vertically, allowing the rotation and slider 112 to be lifted from data storage medium 102. The rate at which slider 112 is lifted from data storage medium 102 is dependent on the slope of surface 122 relative to the data storage plane of data storage medium 102. In some examples, the initial slope of surface 122 may be between five and thirty degrees. In other examples, the initial slope of surface 122 may be about sixteen degrees.

In the final loaded position B, lift tab 116 may rest in a detent at the top of surface 122. The detent in surface 122 may provide a semi-locked position for lift tab 116. This may secure actuator assembly 106 in position B even in the event of an external shock to data storage device 100.

In some examples, ramp component 120 forms groove 124 within surface 122. Groove 124 may reduce the contact area between lift tab 116 and ramp component 120. The reduced contact area between ramp component 120 and lift tab 116 provided by groove 124 may reduce the tangential frictional force from the interface of lift tab 116 and ramp component 120.

Load/unload ramp 120 is shown on the outer diameter of data storage medium 102. In other embodiments, load/unload ramp 120 may be located near the center of data storage medium 102. In either configuration, benefits of detecting ramp load/unload operations are present. As will be described in more detail below, in accordance with this disclosure, an electrical signal, e.g., a voltage, produced by a transducer element used as a microactuator in response to a ramp load/unload operation may be detected using the same electrical connection path used to power the microactuators to finely position the read/write elements during read and write operations.

FIGS. 2A and 2B are illustrations of one example of suspension 107. FIG. 2A is a top view of suspension 107 and FIG. 2B is a bottom view of suspension 107. FIGS. 2A and 2B will be described together. Suspension 107 includes load beam 128. Load beam 128 supports the head gimbal assembly 129 over data storage medium 102, and provides a structure for attaching flex tape 136 from slider 112 to an interface circuit on the disc drive. Load beam 128 includes two support arms 130 and 131 and a stiffening portion 133.

Engaged to suspension 107 is slider 112. Slider 112 includes a read/write head (not shown) with read/write elements for reading data from and writing data to data storage medium 102. Transducer elements 132A and 132B (hereafter “transducer elements 132”) used as microactuators operate to flex load beam 128 in order to move the read/write head of slider 112 during read and write operations. Transducer elements 132 may be used to finely position the read/write elements of the read/write head relative to data tracks on a data storage disc (not shown). In one example, transducers 132A and 132B are connected in parallel and have one side grounded to suspension 107 via electrical interconnects 134A and 134B. Examples of transducers include piezoelectric elements (e.g., lead zirconate titanate (“PZT”)), capacitive devices, and electrostatic devices. Each of these example transducers may be configured to generate a signal upon micro displacement. In one specific example, the signals generated may be the back emf of the PZT transducer elements. Other example transducers not specifically mentioned in the disclosure are nevertheless considered to form part of the disclosure.

Transducer elements 132 may also be used to measure deflections in flexible load beam 128. Transducer elements 132 produce an electrical signal in response to a deflection, such as a deflection occurring when the read/write head contacts a data storage medium (not shown). The electrical signal may be detected using the same electrical connection path used to power transducer elements 132 to finely position the read/write elements. By measuring electrical signals from transducer elements 132, contact between the read/write head and a data storage medium can be reliably detected. Detecting such contact may be useful to determine when maintenance of a head merge station is required to prevent damage to data storage media during the head merge process, for example.

In accordance with this disclosure, an electrical signal produced by one of transducer elements 132A or 132B in response to a ramp load/unload operation may also be detected using the same electrical connection path used to power transducer elements 132 to finely position the read/write elements. As used in this disclosure, the term “ramp load operation” may refer to the initial contact between actuator arm 108/slider 112 and ramp 120. Or, the term “ramp load operation” may refer to the contact between actuator arm 108/slider 112 and ramp 120 as actuator arm 108 moves up ramp 120. Or, the term “ramp load operation” may refer to the initial contact between actuator arm 108/slider 112 and ramp 120, as well as the contact between actuator arm 108/slider 112 and ramp 120 as actuator arm 108 moves up ramp 120. Similarly, the term “ramp unload operation” may refer to the contact between actuator arm 108/slider 112 and ramp 120 as actuator arm 108 moves down ramp 120. Or, the term “ramp unload operation” may refer to the final contact between actuator arm 108/slider 112 and ramp 120 as actuator 108 moves completely off ramp 120. Or, the term “ramp load operation” may refer to the contact between actuator arm 108/slider 112 and ramp 120 as actuator arm 108 moves down ramp 120, as well as the final contact between actuator arm 108/slider 112 and ramp 120 as actuator 108 moves completely off ramp 120. By detecting the electrical signal produced by a transducer element 132 in response to a ramp load/unload operation, the accuracy of ramp load/unload detection may be improved and the complexity of detection algorithms may also be reduced.

It should be noted that although the disclosure describes examples in which the electrical signal generated by a transducer element 132 used as a microactuator is used to detect ramp load and ramp unload operations, other examples consistent with the disclosure may use a transducer for ramp load and ramp unload detection that is mechanically engaged to the suspension, actuator arm, or the like that performs no microactuation function whatsoever. That is, the transducer may be used for the sole purpose of detecting ramp load or unload operations.

Further, it should be noted that although the disclosure describes using a signal for detecting a ramp load or unload operation, there may be additional signals used. For example, in a data storage device that includes multiple data storage media and therefore multiple actuator arms, signals in addition to the signal generated by either transducer 132A or 132B may be used to detect ramp load and ramp unload operations.

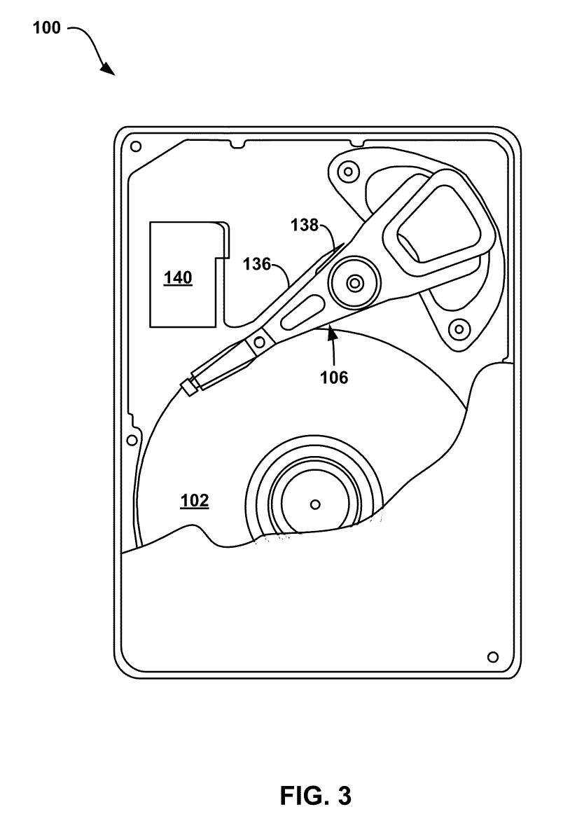

FIG. 3 is an illustration of one example of data storage device 100 including electrical connection paths. Flex tape 136 provides electrical connection paths to control actuator assembly 106 and allows pivotal movement of actuator assembly 106 during operation. Printed circuit board 138 controls read and write operations of the read/write head. Flex tape 136 terminates at flex bracket 140.

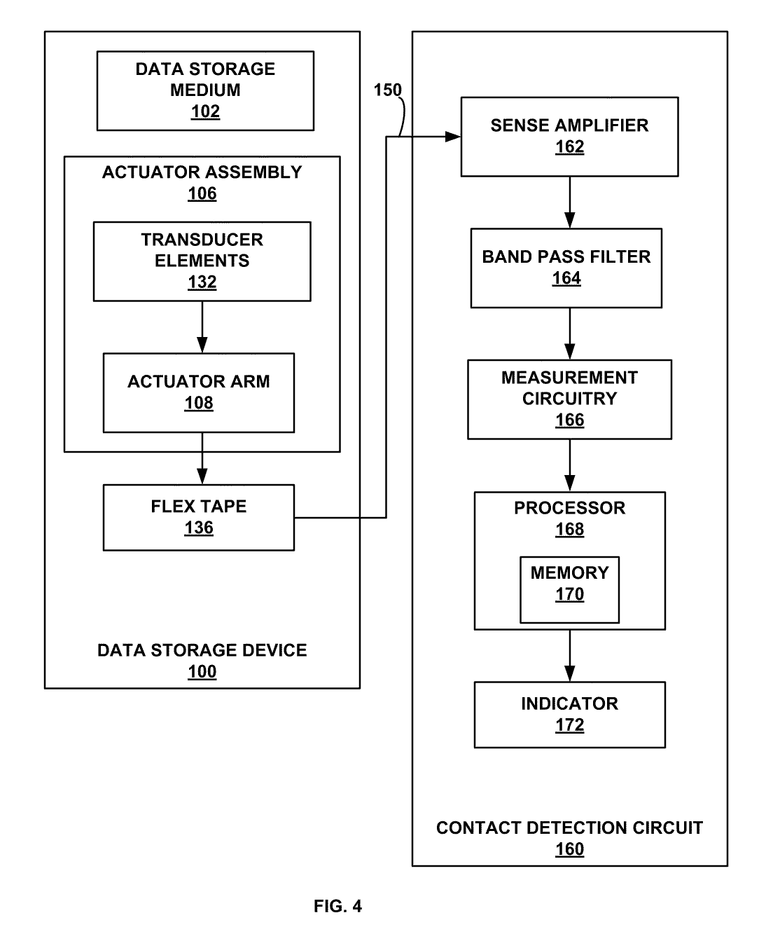

FIG. 4 is a conceptual block diagram illustrating one example of signal path 150 in one example of a ramp load/unload operation detection circuit. Signal path 150 includes data storage device 100 and contact detection circuit 160. Signal path 150 begins with transducer elements 132, which are in electrical communication with flex tape 136 via suspension 107. Transducer elements 132 move in response to an electrical signal and, conversely, generate an electrical signal in response to deflection. For example, transducer elements 132 may comprise one or more piezoelectric crystals, capacitive devices, electrostatic devices, and/or other microactuation mechanisms that generate electrical signals in response to deflection. In some examples, the piezoelectric crystals, capacitive devices, electrostatic devices, and/or other microactuation mechanisms generate an electrical voltage. Contact detection circuit 160 is in electrical communication with transducers 132 via flex tape 136 and suspension 107 of data storage device 100.

Data storage device 100 includes one or more data storage media 102. Each data storage medium 102 includes one or more data storage surfaces (e.g., magnetically recordable data storage surfaces). Data storage device 100 also includes actuator assembly 106 and flex tape 136. Actuator assembly 106 includes actuator arm 108 having suspension 107 and one or more read/write heads for each of the data storage surfaces of media 102. The read/write heads each include one or more head positioning transducer elements or microactuators 132.

Contact detection circuit 160 optionally includes sense amplifier 162, which amplifies signals received from transducer elements 132. Contact detection circuit 160 also optionally includes band pass filter 164, which may isolate portions of output signals from one of transducer elements 132 that indicate ramp load/unload operation.

Contact detection circuit 160 includes measurement circuitry 166 that measures the value of the signal from transducer elements 132 received from signal path 150. Contact detection circuit further includes processor 168 that analyzes the value of the signal to determine whether a ramp load/unload operation has occurred. Processor 168 may also perform additional analysis on signal information, as well as executing instructions stored in memory 170 to log data to memory 170, as will be described in more detail below. Although memory 170 is shown in FIG. 4 as residing within processor 168, it is understood that memory 170 may be a separate memory device in electrical communication with processor 168. If present, indicator 172 may produce an indication or alarm that a ramp load or unload operation has occurred. In some examples, indicator 172 may be a visible indication or alarm. In other examples, indicator 172 may be an audible indication or alarm.

By way of specific example, during a ramp load operation, a transducer element 132 may generate a signal, e.g., a voltage, during the initial contact between actuator arm 108 and ramp 120. The signal is conducted through flex tape 136 to contact detection circuit 160. Sense amplifier 162 may amplify the signal received via flex tape 136 and then forward the amplified signal to band pass filter 164, if present. Band pass filter 164 may isolate portions of the signal that indicate ramp load/unload operation. The signal is then forwarded to measurement circuitry 166. Measurement circuitry 166 measures the value of the signal generated by one of the two parallel connected transducer elements 132. Contact detection circuit includes processor 168 that analyzes the signal value to determine whether a ramp load/unload operation has occurred. Processor 168 may also perform additional analysis on signal information, as well as executing instructions stored in memory 170 to log data to memory 170. Although memory 170 is shown in FIG. 4 as residing within processor 168, it is understood that memory 170 may be a separate memory device in electrical communication with processor 168. If present, indicator 172 may produce an indication or alarm that a ramp load or unload operation has occurred.

Processor 168 may analyze the signal value by comparing the value to a threshold value. For example, if data storage device 100 is performing a ramp load operation, and thus moving actuator arm 108 off of data storage medium 102 and onto ramp 120, the initial contact between actuator arm 108 and ramp 120 may cause one of transducer element 132A or transducer element 132B to generate a signal, e.g., a voltage. Then, processor 168 compares the value to a threshold value stored in a memory either located within processor 168, such as memory 170, or in electrical communication with processor 168. If the value exceeds the threshold value, then processor 168 determines that a ramp load or unload operation has begun.

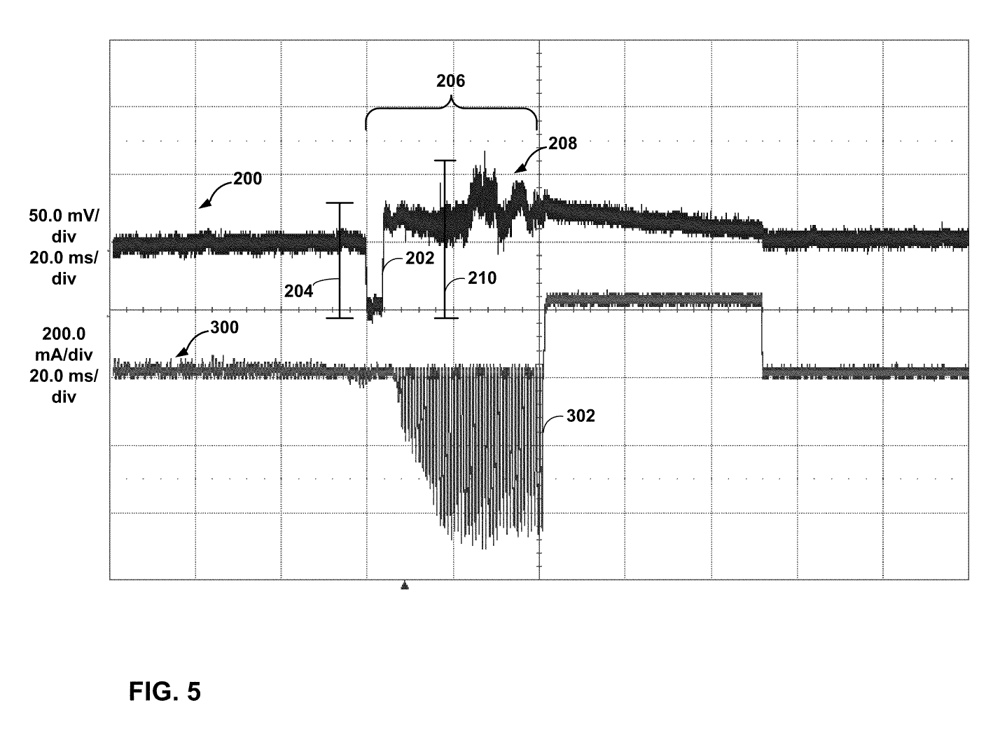

FIG. 5 depicts a graph illustrating one example of a signal generated by one of transducer elements 132A or 132B during a sequence in which power to data storage device 100 has been turned off and a load operation has begun. The top graph, graph 200, plots the value of the signal, or voltage in this graph, generated by transducer element 132A or transducer element 132B. The scale of graph 200 is 50.0 millivolts (mV) per vertical division and 20.0 milliseconds (ms) per horizontal division. As seen in FIG. 5, a spike 202 occurs in the voltage. Spike 202 occurred during the initial ramp contact between an actuator arm 108 and ramp 120. As seen in FIG. 5, spike 202 is approximately 1.5 vertical divisions, or approximately 75 mV, as indicated at 204. By collecting data, for example, a threshold value may be determined such that if the voltage 200 is greater than the threshold value, processor 168 determines that a ramp load operation has begun. By way of specific example, if a threshold value of 50 mV was set as a threshold value, then measurement circuitry 166 and processor 168 monitoring the voltage shown in graph 200 may determine that because the approximately 75 mV signal exceeds the 50 mV threshold value, a ramp load operation has begun.

In some examples, the threshold value may be a static value. That is, the stored threshold value may be constant over time. For example, the threshold value may be calculated and stored during manufacture of the data storage device and remain constant until manually reprogrammed, for example.

In other examples, the threshold value may be a dynamic value. That is, the stored value may automatically adjust over time. For example, the threshold value may be calculated and stored during manufacture of the data storage device, but the threshold value may be automatically adjusted over time to account for variations in the detected transducer element signals. For example, the threshold value may be determined and stored during manufacture of the data storage device. Then, processor 168 may be configured to execute instructions that result in data related to the signal, e.g., the signal generated by transducer element 132A, being stored to memory 170. Over time, the value of the signal generated by transducer element 132A or 132B may increase or decrease. Processor 168 may be configured to execute instructions that cause the dynamic threshold value to be automatically adjusted accordingly to account for the variation in the signal value. In this manner, the threshold value may be maintained at a certain level above an averaged detected signal value, thereby allowing swings in calibration of the data storage device.

In other examples, processor 168 may analyze the signal value over a period of time longer than that of spike 202. For example, processor 168 may analyze the signal value over a time period 206, as shown in FIG. 5. Time period 206 includes not only spike 202 indicative of initial contact between the actuator arm and the ramp, but also the contact between the actuator arm and the ramp as the arm moves along or up the ramp. The contact between the actuator arm and the ramp as the arm moves up the ramp is shown generally at 208. As shown graphically in the specific example of FIG. 5 at 210, the signal value over time period 206 is approximately two vertical divisions, or approximately 100 mV. By way of specific example, if a threshold value of 75 mV was set as a threshold value, then measurement circuitry 166 and processor 168 monitoring the voltage shown in graph 200 may determine that because the approximately 100 mV signal exceeds the 75 mV threshold value, a ramp load operation has been completed. Using a longer time period such as time period 206, as compared to the time period during spike 202, may be useful in determining that the ramp load operation has been completed.

In another example, processor 168 may analyze the signal by performing a trend analysis to determine whether a ramp load (or unload) operation has occurred. Referring again to FIG. 5, a trend can be seen over time period 206. The trend includes initial spike 202 followed by the contact between the actuator arm and the ramp as the arm moves up the ramp, as shown generally at 208. Processor 168 may compare signal values 200 over time period 206 to a pre-programmed trend of signal values over time. Specifically, processor 168 may use signal processing techniques such as digital signal processing in order to correlate a series of samples of the values 200 over time period 206 with data defining a waveform or pattern known to be indicative of a ramp load or unload process. The data defining the waveform or pattern known to be indicative of a ramp load or unload process may be stored in memory, such as memory 170 or in memory in electrical communication with processor 168. After comparison and analysis, processor 168 may determine that there is enough similarity between the values 200 over time and the known trend or pattern to indicate that a ramp load operation is occurring or has occurred. In such a manner, a ramp load (or unload) operation may be detected.

It should be noted that any portion of time period 206 may be used in determining whether a ramp load operation has been completed. Although only the portion of time period 206 that includes the initial contact between the actuator arm and ramp (spike 202), and the entire time period 206 that includes both the initial contact between the actuator arm and the ramp, as well as the contact as the actuator arm moves up the ramp, have been described, any other portions of the time period 206 may be used to determine whether a ramp load operation has occurred. For example, a trend analysis may include only the portion of time period 206 that includes the contact of the actuator arm and the ramp as the arm moves up the ramp, excluding the initial contact.

The bottom graph shown in FIG. 5, graph 300, depicts the voice coil motor (VCM) current as the actuator arm moves during a ramp load operation. The scale of graph 300 is 200.0 milliamps (mA) per vertical division and 20.0 milliseconds (ms) per horizontal division. Graph 300 illustrates a spike 302 occurring in the VCM current at approximately the same time as the actual ramp contact.

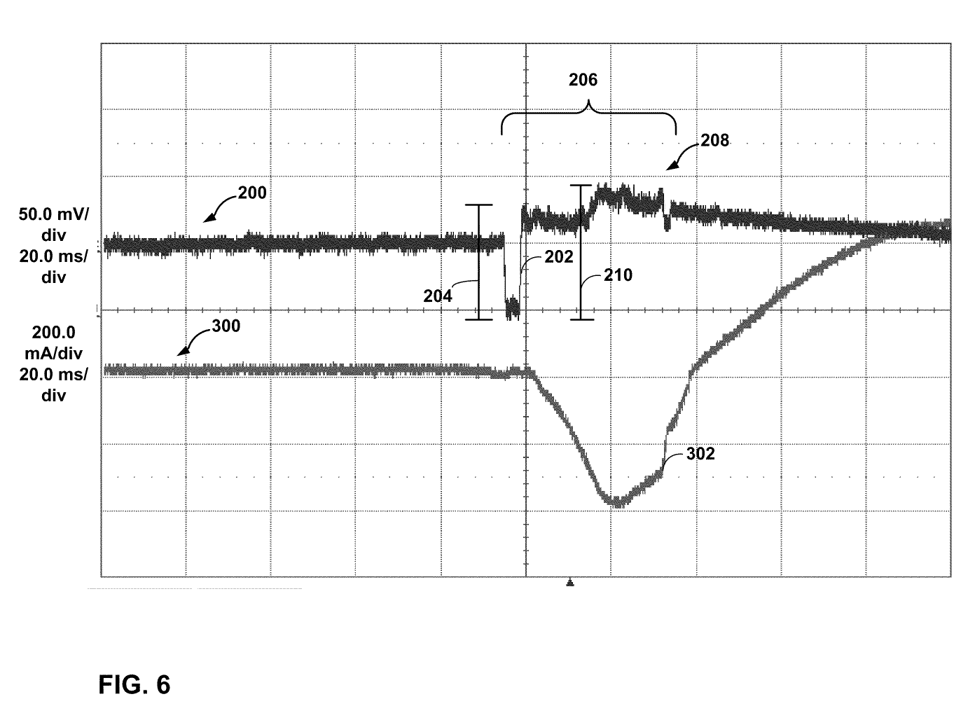

FIG. 6 depicts a graph illustrating one example of a signal generated by transducer elements 132 during a commanded load operation. A commanded load operation may occur in response to a software command issued by an interface or by servo code. A commanded load operation may occur when a data storage device, e.g., a disc drive, is spinning up, enters into a lower power mode, or is in idle state. The top graph, graph 200, plots the signal value, or voltage in this graph, generated by transducer element 132A or transducer element 132B. The scale of graph 200 is 50.0 mV per vertical division and 20.0 ms per horizontal division. As seen in FIG. 6, a spike 202 occurs in the voltage. Spike 202 occurred during the initial ramp contact between an actuator arm and a ramp. As seen in FIG. 6, spike 202 is approximately 50 mV, as indicated at 204. FIG. 6 also depicts a time period 206 that includes not only spike 202 indicating initial contact between the actuator arm and the ramp, but also the contact between the actuator arm and the ramp as the arm moves up the ramp, like in FIG. 5. As shown graphically in the specific example of FIG. 6, the value over time period 206 is approximately two vertical divisions, or approximately 100 mV.

All of the techniques for detecting a ramp load operation described above in conjunction with the power off and load operation of FIG. 5 may also be used for detecting a ramp load operation in a commanded load operation like in FIG. 6. That is, in some examples, the threshold value may be static or dynamic. In other examples, a trend analysis may be used to detect a ramp load operation. In some examples, a value indicating initial contact between the actuator arm and the ramp may be used to detect ramp load operation. And, in other examples, a value may indicate initial contact between the actuator arm and the ramp as well as the contact as the actuator arm moves up the ramp may be used to detect ramp load operation.

The bottom graph shown in FIG. 6, graph 300, depicts the VCM current as the actuator arm moves during a ramp load operation. The scale of graph 300 is 200.0 mA per vertical division and 20.0 ms per horizontal division. Graph 300 illustrates a spike 302 occurring in the VCM current at approximately the same time as the actual ramp contact.

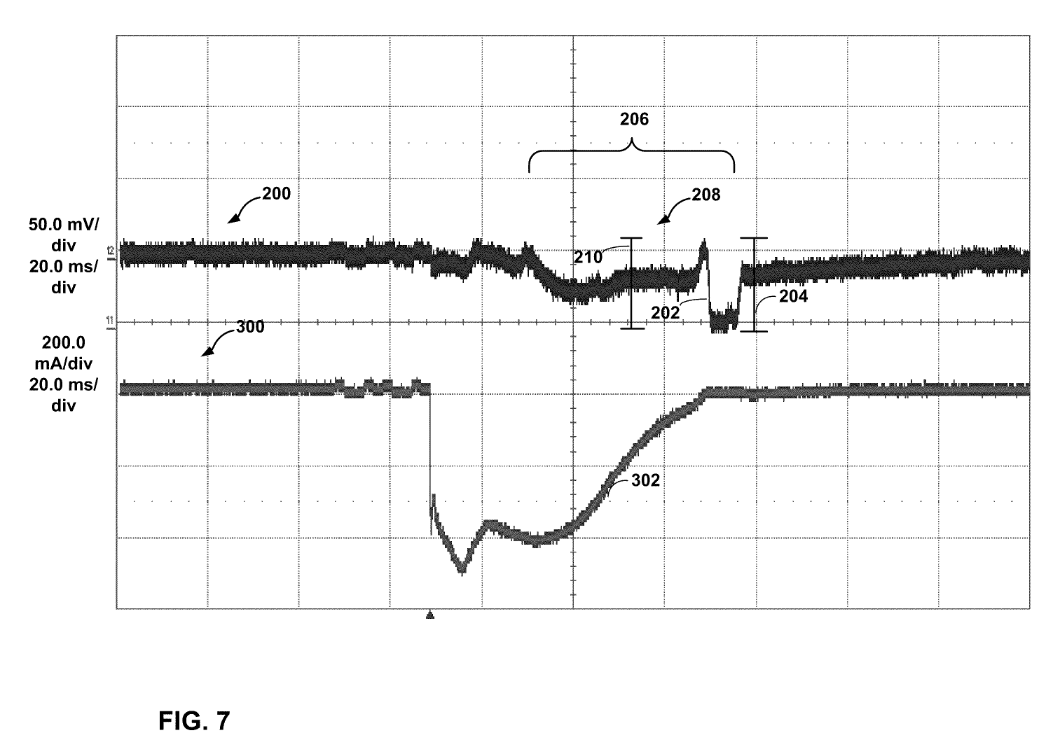

FIG. 7 depicts a graph illustrating one example of a signal generated by a transducer element 132 during a commanded unload operation. A commanded unload operation may occur in response to a software command issued by an interface or by servo code. A commanded unload operation may occur when a data storage device, e.g., a disc drive, is spinning down the drive. The top graph, graph 200, plots the value, or voltage in this graph, generated by transducer element 132A or transducer element 132B. The scale of graph 200 is 50.0 mV per vertical division and 20.0 ms per horizontal division. FIG. 7 illustrates signal values as the actuator arm moves along or down the ramp, as shown generally at 208. Like in FIGS. 5 and 6, a spike 202 occurs in the voltage. Spike 202 occurred as the actuator arm completely unloaded off the ramp during a final contact with the ramp.

As seen in FIG. 7, spike 202 is approximately 1.25 vertical divisions, over about 63 mV, as indicated at 204. And, as also seen graphically at 210 in the specific example of FIG. 7, the value over time period 206 is approximately 1.25 divisions, or approximately 63 mV. All of the techniques for detecting a ramp load operation described above in conjunction with the power off and load operation of FIG. 5 and the commanded load operation of FIG. 6 may also be used for detecting a ramp unload operation in a commanded unload operation like in FIG. 7. That is, in some examples, the threshold value may be static or dynamic. In other examples, a trend analysis may be used to detect a ramp unload operation. In some examples, a value indicating the actuator arm completely unloading off the ramp may be used to detect a ramp unload operation. And, in other examples, a value indicating the contact as the actuator arm moves down the ramp as well as the actuator arm completely unloading off the ramp may be used to detect a ramp unload operation.

The bottom graph shown in FIG. 7, graph 300, depicts the VCM current as the actuator arm moves during a ramp load operation. The scale of graph 300 is 200.0 mA per vertical division and 20.0 ms per horizontal division. Graph 300 illustrates a spike 302 occurring in the VCM current at approximately the same time as the actual ramp contact.

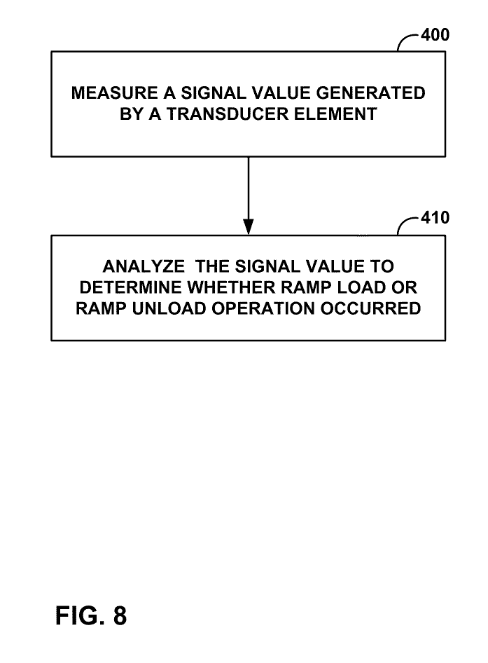

FIG. 8 is a flow chart illustrating an example method for detecting a ramp load or ramp unload operation. In the method illustrated in FIG. 8, measurement circuitry 166 measures a signal value generated by one of transducer elements 132 during a ramp load or unload operation (400). Processor 168 analyzes the signal value to determine whether a ramp load or ramp unload operation has occurred (410). Processor 168 may compare the signal value to a threshold value(s), or perform a trend analysis, for example, in order to determine whether a ramp load or ramp unload operation has occurred.

In some examples, the threshold value may be either a predetermined static value or a dynamic value.

In other examples, analyzing the signal value may include comparing the signal value to previously stored data, wherein the previously stored data is representative of a trend of signal values over, and determining whether the ramp load operation or the ramp unload operation in the data storage device has occurred based upon the comparison.

In some examples, the transducer element may be selected from a group consisting of a piezoelectric element, a capacitive element, and an electrostatic element.

In other examples, the signal value may comprise a first value indicating at least one of an initial ramp contact and a final ramp contact, and a second value indicating movement along the ramp.

The techniques described in this disclosure may, in some cases, improve the detection accuracy of ramp load and unload operations. For example, PZT voltage gain is very high, resulting in a high signal to noise ratio that may improve accuracy in detection. The techniques described in this disclosure may also be used to reduce dwell track locations because the ramp load and unload times are accurately known. The techniques described in this disclosure may also be used to perform axial run-out checks, and eliminate a test station during manufacture.

Further, the techniques described in this disclosure may also be used to determine a ramp contact radius. That is, optimizing the ramp load/unload detection may mitigate potential head/media contact, media damage, and particle generation.

In addition, the techniques described in this disclosure may also be used to detect individual heads or head gimbal assembly contact.

The techniques described in this disclosure may also be used to determine that the actuator is on the ramp during ramp unload and thus optimize acoustics.

The techniques described in this disclosure may be implemented in hardware, software, firmware, or any combination thereof. In particular, the techniques may be implemented in a hardware device that may include software and/or firmware to support the implementation. For portions implemented in software, the techniques may be realized in part by a computer-readable medium comprising program code containing instructions that, when executed, performs one or more of the methods described above. In this case, the computer readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like.

The program code may be executed by one or more processors, such as one or more digital signal processors (DSPs), general purpose microprocessors, an application specific integrated circuits (ASICs), field programmable logic arrays (FPGAs), or other equivalent integrated or discrete logic circuitry. In this sense, the techniques are implemented in hardware, whether implemented entirely in hardware or in hardware such as a processor executing computer-readable code. The term “processor,” as used herein may refer to any of the foregoing structure or any other structure suitable for implementation of the techniques described herein.

The implementations described above and other implementations are within the scope of the following claims.

1. A method comprising:
measuring a signal value generated by a transducer element during either a ramp unload operation or a ramp load operation in a data storage device; and
analyzing the signal value to determine whether the ramp load operation or the ramp unload operation in the data storage device has occurred.

2. The method of claim 1, wherein analyzing the signal value comprises:
comparing the signal value to a threshold value; and
determining whether the ramp load operation or the ramp unload operation in the data storage device has occurred based upon the comparison.

3. The method of claim 2, wherein the threshold value is one of either a predetermined static value or a dynamic value, wherein the dynamic value automatically adjusts over time.

4. The method of claim 1, wherein analyzing the signal value comprises:
comparing the signal value to previously stored data, wherein the previously stored data is representative of a trend of signal values over time; and
determining whether the ramp load operation or the ramp unload operation in the data storage device has occurred based upon the comparison.

5. The method of claim 1, wherein the transducer element is selected from a group consisting of a piezoelectric element, a capacitive element, and an electrostatic element.

6. The method of claim 1, wherein the signal value comprises a first value indicating at least one of an initial ramp contact and a final ramp contact, and a second value indicating movement along the ramp.

7. A data storage device comprising:
a data storage medium;
an actuator arm comprising a suspension;
a transducer element in mechanical communication with the suspension;
a ramp component forming a surface; and
a processor in electrical communication with the transducer element,
wherein when the slider is unloaded or when the slider is loaded, the transducer element generates a signal value,
wherein the processor analyzes the signal value to determine whether a ramp load operation or a ramp unload operation in the data storage device has occurred.

8. The device of claim 7, wherein the slider is loaded when the actuator arm moves such that it is supported by the surface of the ramp component, and wherein the slider is unloaded when the actuator arm moves such that it is unsupported by the surface of the ramp component.

9. The device of claim 7, wherein the processor compares the signal value to a threshold value, and wherein the processor determines whether the slider has completed a ramp load operation or a ramp unload operation based upon the comparison.

10. The device of claim 9, wherein the threshold value is one of either a predetermined static value or a dynamic value, wherein the dynamic value automatically adjusts over time.

11. The device of claim 7, wherein when analyzing the signal value, the processor is configured to:
compare the signal value to previously stored data, wherein the previously stored data is representative of a trend; and
determine whether the ramp load operation or the ramp unload operation in the data storage device has occurred based upon the comparison.

12. The device of claim 7, wherein the transducer element is selected from the group consisting of piezoelectric elements, capacitive elements, and electrostatic elements.

13. The device of claim 7, wherein the signal value comprises a first value indicating at least one of initial ramp contact and final ramp contact, and a second value indicating movement along the ramp.

14. A computer-readable medium comprising instructions that cause a processor in electrical communication with a data storage device to:
measure a signal value generated by a transducer element during either a ramp unload operation or a ramp load operation in a data storage device; and
analyze signal value to determine whether the ramp load operation or the ramp unload operation in the data storage device has occurred.

15. The computer-readable medium of claim 14, wherein the instructions that cause the processor to analyze the signal value further comprise instructions that cause the processor to:
compare the signal value to a threshold value; and
determine whether the ramp load operation or the ramp unload operation in the data storage device has occurred based upon the comparison.

16. The computer-readable medium of claim 15, wherein the threshold value is one of either a predetermined static value or a dynamic value, wherein the dynamic value automatically adjusts over time.

17. The computer-readable medium of claim 14, wherein the instructions that cause the processor to analyze the signal value comprise instructions that cause the processor to:
compare the signal value to previously stored data, wherein the previously stored data is representative of a trend of signal values over time; and
determine whether the ramp load operation or the ramp unload operation in the data storage device has occurred based upon the comparison.

18. The computer-readable medium of claim 14, wherein the transducer element is selected from the group consisting of piezoelectric elements, capacitive elements, and electrostatic elements.

19. The computer-readable medium of claim 14, wherein the signal value comprises a first value indicating at least one of initial ramp contact and final ramp contact, and a second value indicating movement along the ramp.
